(19) United States
(12) Patent Application Publication
(10) Pub. No.: US 2014/0169871 A1
(43) Pub. Date: Jun. 19, 2014

(54) CONNECTOR

(71) Applicant: Yazaki Corporation, Tokyo (JP)

(72) Inventor: Noritaka NISHIYAMA, Makinohara-shi (JP)

(73) Assignee: Yazaki Corporation, Tokyo (JP)

(21) Appl. No.: 14/183,666

(22) Filed: Feb. 19, 2014

Related U.S. Application Data
(63) Continuation of application No. PCT/JP2012/071931, filed on Aug. 23, 2012.

(30) Foreign Application Priority Data
Aug. 23, 2011 (JP) 2011-181774

(51) Int. Cl. H01R 13/436; F16B 17/00

(52) U.S. Cl. CPC H01R 13/436; F16B 17/00
USPC 403/374.1

(57) ABSTRACT

A connector includes a housing body and an attachment component that is inserted in a component containing space of the housing body. The attachment component has a side wall extending in an insertion direction of the attachment component into the component containing space. The housing body includes a provisionally retaining portion and a completely retaining portion. The attachment component has a first projection portion which is retained to the provisionally retaining portion at a provisionally retaining position. The attachment component has a second projection portion which is retained to the completely retaining portion at a completely retaining position. The side wall includes a wave shaped plate section having elasticity, and the wave shaped plate section has the first and second projection portions which are formed in a shape of a wave progressing along the insertion direction.

### CROSS REFERENCE TO RELATED APPLICATIONS

This application is a continuation of PCT application No. PCT/JP2012/071931, which was filed on Aug. 23, 2012 based on Japanese Patent Application (No. 2011-181774) filed on Aug. 23, 2011, the contents of which are incorporated herein by reference.

### BACKGROUND OF THE INVENTION

1. Field of the Invention

The present invention relates to a connector with an attachment component, especially, a retaining structure of the attachment component in the connector in which an attachment component inserted into a component containing space of a housing body of the connector is positioned on one of two positions of a provisionally retaining position and a completely retaining position.

2. Description of the Related Art

FIG. 6 is a schematic view illustrating a retaining structure of an attachment component in a connector disclosed in JP-A-64-54678 as described below.

A connector 100 shown in FIG. 6 is provided with a spacer 110 as an attachment component and a housing body 120 having a component containing space 121 in which the spacer 110 is inserted in a direction of arrow Y1 to be attached therein.

The spacer 110 is a component which is to be attached to the component containing space 121 in the connector 100 as a double retaining mechanism for a terminal metal fitting (not shown) attached to a terminal insertion hole 122 of the housing body 120. The spacer 110 is provided with a terminal retaining portion 111, a projection portion 112 for provisionally retaining and a projection portion 113 for completely retaining.

The terminal retaining portion 111 is a projection which is adapted to be engaged with a terminal metal fitting attached to the terminal insertion hole 122 so as to prevent dropping out of the terminal metal fitting.

The projection portion 112 for provisionally retaining is a projection which is retained to a provisionally retaining portion (not shown) provided on the housing body 120 when an insertion length of the spacer 110 into the component containing space 121 reaches a first specified value so that the spacer 110 is positioned on a provisionally retaining position. In a state that the spacer 110 is positioned on the provisionally retaining position, the terminal retaining portion 111 is not placed in the terminal insertion hole 122, and inserting and extracting of the terminal metal fitting into or from the terminal insertion hole 122 is permitted.

The projection portion 113 for completely retaining is a projection which is retained to a completely retaining portion 124 provided on the housing body 120 when the insertion length of the spacer 110 into the component containing space 121 exceeds the first specified value and reaches a second specified value so that the spacer 110 is positioned on a completely retaining position. In a state that the spacer 110 is positioned on the completely retaining position, the terminal retaining portion 111 is plunged into the terminal insertion hole 122 to be engaged with the terminal metal fitting so that dropping off of the terminal metal fitting is restricted.

The retaining structure of the attachment component in the connector 100 disclosed in JP-A-64-54678 is configured such that the spacer 110 as the attachment component is provided with the projection portion 112 for provisionally retaining and the projection portion 113 for completely retaining which are projected in a direction perpendicular to an insertion direction to the component containing space 121. On the other hand, the housing body 120 is provided with a provisionally retaining portion for retaining the projection portion 112 for provisionally retaining and a completely retaining portion 124 for retaining the projection portion 113 for completely retaining at respective positions facing the component containing space 121.

### SUMMARY OF THE INVENTION

Meanwhile, in a rigid structure in which both of portions such as, for example, the projection portion 113 for completely retaining and the completely retaining portion 124 to be engaged with each other between the spacer 110 and the housing body 120, are hard, and are not elastically deformed. Therefore, if an excessive load is applied to them in the event of engagement, the engaged portions may be crushed or broken, i.e., the engaged portions may be damaged.

Therefore, in the retaining structure of an attachment component in a connecter described in JP-A-64-54678, a slit 126 is provided on the housing body 120 at a position adjacent to the completely retaining portion 124 provided on the housing body 120 so that the completely retaining portion 124 can be elastically deformed in the event of engagement, thereby preventing the engagement portions from being damaged.

However, in a countermeasure in which the slit 126 is provided on a wall portion of the housing body 120, problems may arise that it is necessary to prepare a sliding die having complicated structure as a molding die for molding the housing 120, and thereby increase of the cost of the molding die results in increase of the manufacturing cost.

Consequently, the purpose of the present disclosure is to solve the above problems and to provide a connector in which parts to be mutually engaged between an attachment component and a housing body can be safely moved to an engaged state by elastic deformation of one of them without causing a damage even when a slit or the like which may require an expensive sliding die is not provided.

The purpose of the present disclosure is achieved by the following aspects.

(1) There is provided a connector comprising:

a housing body that has a component containing space; and
an attachment component that is inserted in the component containing space of the housing body, and has a side wall extending in an insertion direction of the attachment component into the component containing space,
wherein the housing body includes a provisionally retaining portion and a completely retaining portion;

wherein the attachment component has a first projection portion which is retained to the provisionally retaining portion so as to position the attachment component on a provisionally retaining position when the attachment component is inserted into the component containing space by a first insertion length;

wherein the attachment component has a second projection portion which is retained to the completely retaining portion so as to position the attachment component on a completely retaining position when the attachment component is inserted into the component containing space by a second insertion length which is longer that the first insertion length; and
wherein the side wall of the attachment component includes a wave shaped plate section having elasticity, and the wave shaped plate section has the first projection portion and the second projection portion which are formed in a shape of a wave progressing along the insertion direction of the attachment component.

For example, when a pressure load is applied to at least one of the first projection portion and the second projection portion, the at least one of the first projection portion and the second projection portion is elastically deformed in a flat shape by the pressure load and the wave shaped plate section is expanded in the insertion direction of the attachment component.

For example, the first projection portion and the second projection portion extend over a whole width of the side wall in a direction perpendicular to the insertion direction of the attachment component.

For example, the first projection portion and the second projection portion a pair of concave and convex portions continuously formed on the wave shaped plate section.

For example, a rib for increasing elastic strength of the first projection portion and the second projection portion is extended on one face of the wave shaped plate section in the insertion direction of the attachment component.

For example, the first projection portion is formed on a first face of the wave shaped plate section and the second projection portion is formed on a second face of the wave shaped plate section which is opposite to the first face.

For example, the wave shaped plate section is arranged between the provisionally retaining portion and the completely retaining portion when the attachment component is inserted into the component containing space by the second insertion length.

In accordance with the configuration of the aspect (1), the first projection portion and the second projection portion on the attachment component are provided on the wave shaped plate section formed on the side wall extending along the insertion direction of the attachment component. Each of the first and second projection portions functions as a plate spring which is elastically deformed in the flat shape by the pressure load that the projection portion receives when it is brought into contact with the provisionally retaining portion or the completely retaining portion at the housing body. Therefore, even when a slit or the like is not provided, engagement between the first projection portion and the provisionally retaining portion or between the second projection portion and the completely retaining portion can be completed without applying an excessive load to parts to be mutually engaged between the attachment component and the housing body.

Consequently, by the above configuration, even when a slit or the like which may require an expensive sliding die is not provided, the parts to be mutually engaged between the attachment component and the housing body can be safely moved to an engaged state by an elastic deformation of one of them without causing a damage.

In addition, it is possible to obviate the need for a sliding die which is adapted to mold the housing body or the like and has a complicated structure so that a structure of a molding die can be simplified, and thereby the manufacturing cost can be reduced.

In accordance with the above configurations, the first projection portion or the second projection portion provided on the attachment component is formed so as to extend over the whole width of the side wall extending along the insertion direction of the attachment component. As a result, a width dimension of the provisionally retaining portion or the completely retaining portion provided on the housing body is made to be an engagement width between the attachment component and the housing body. Therefore, it is possible to readily adjust the engagement strength between the attachment component and the housing body only by changing the width dimension of the provisionally retaining portion or the completely retaining portion provided on the housing body. Consequently, it is possible to facilitate the adjusting of the engagement strength between the attachment component and the housing body.

In accordance with the above configurations, the first projection portion and the second projection portion provided on the attachment component are a pair of concave and convex portions continuously formed in the shape of the wave on the wave shaped plate section. Therefore, the length dimension of the wave shaped plate section along the insertion direction thereof can be reduced to be one corresponding to one cycle of the wave. With this, as compared to a case in which the length of the wave shaped plate section in the insertion direction thereof is made to correspond to multiple cycles of the wave, the shape of the side plate in the component containing space can be simplified, and thereby moldability of the attachment component can be improved.

In accordance with the above configurations, by adjusting the thickness or the like of the rib, the elastic strength of the first and second projection portions on the wave shaped plate section, can be readily adjusted, and thereby the projection portions having the desired elastic strength can be readily obtained.

In accordance with the connector according to the present disclosure, the projection portion for provisionally retaining or the projection portion for completely retaining provided on the attachment component is the wave shaped projection on the wave shaped plate section formed on the side wall extending along the insertion direction of the attachment component. Each of the projection portions functions as a plate spring which is elastically deformed in a flat shape by a pressure load that the projection portion receives when it is brought into contact with the provisionally retaining portion or the completely retaining portion at the housing body side.

Therefore, even when a slit or the like is not provided, engagement between the projection portion for provisionally retaining and the provisionally retaining portion or between the projection portion for completely retaining and the completely retaining portion can be completed without applying an excessive load to the parts to be mutually engaged between the attachment component and the housing body.

Consequently, in accordance with the present disclosure, even when a slit or the like which may require an expensive sliding die is not provided, the parts to be mutually engaged between the attachment component and the housing body can be safely moved to an engaged state by an elastic deformation of one of them without causing a damage.

In addition, it is possible to obviate the need for a sliding die which is adapted to mold the housing body or the like and has a complicated structure so that a structure of a molding die can be simplified, and thereby the manufacturing cost can be reduced.

### BRIEF DESCRIPTION OF THE DRAWINGS

FIG. 1 is an exploded perspective view illustrating a housing body and a spacer in a connector according to a first embodiment of the present disclosure.

FIG. 2 is an enlarged perspective view illustrating the spacer shown in FIG. 1.

FIG. 3 is an elevational view illustrating the spacer shown in FIG. 2.

FIG. 4A is a schematic view explanatorily illustrating an insertion state that the spacer inserted into a spacer containing space of the housing body of the first embodiment is not yet provisionally retained, FIG. 4B is a schematic view explanatorily illustrating a state that the insertion is advanced from the state shown in FIG. 4A and a projection portion for provisionally retaining of the spacer is in a way of getting over a provisionally retaining portion of the housing body, FIG. 4C is a schematic view explanatorily illustrating a state that the insertion is advanced from the state shown in FIG. 4B and the spacer is positioned on a provisionally retaining position, and FIG. 4D is a schematic view explanatorily illustrating a state that the insertion is advanced from the state shown in FIG. 4C and the spacer is positioned on a completely retaining position.

FIG. 5 is a schematic view illustrating a main part of a spacer having a projection portion for provisionally retaining and a projection portion for completely retaining according to a second embodiment of the present disclosure.

FIG. 6 is a schematic view explanatorily illustrating a retaining structure of an attachment component in a related connector.

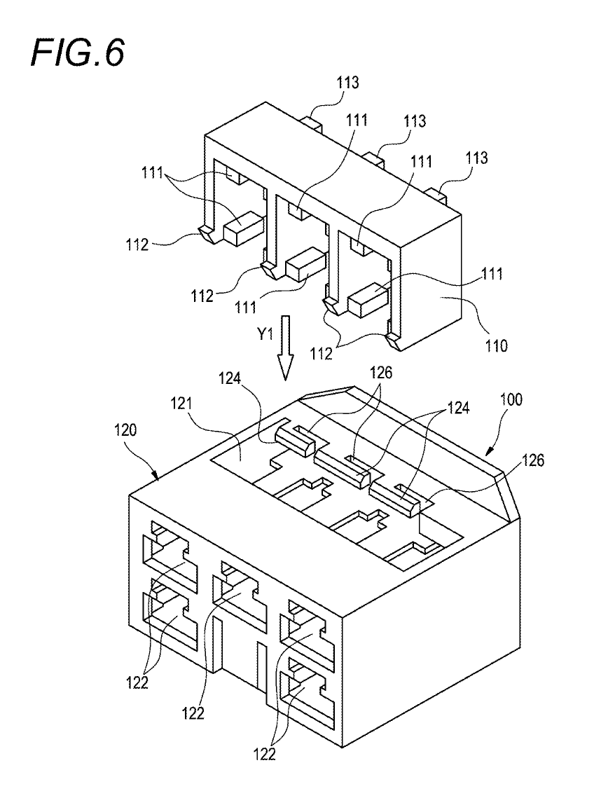

### DETAILED DESCRIPTION OF THE EXEMPLARY EMBODIMENTS

A connecter having an attachment component in a according to a preferable embodiment of the present disclosure is described below in detail with reference to accompanying drawings.

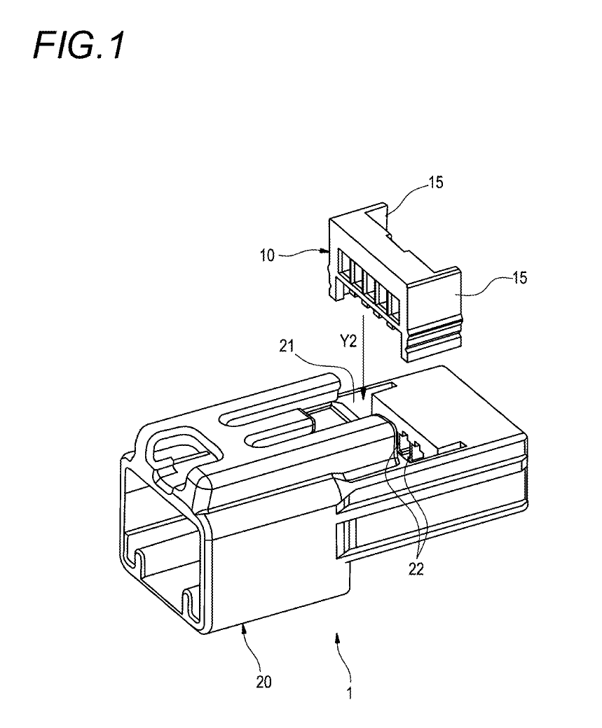

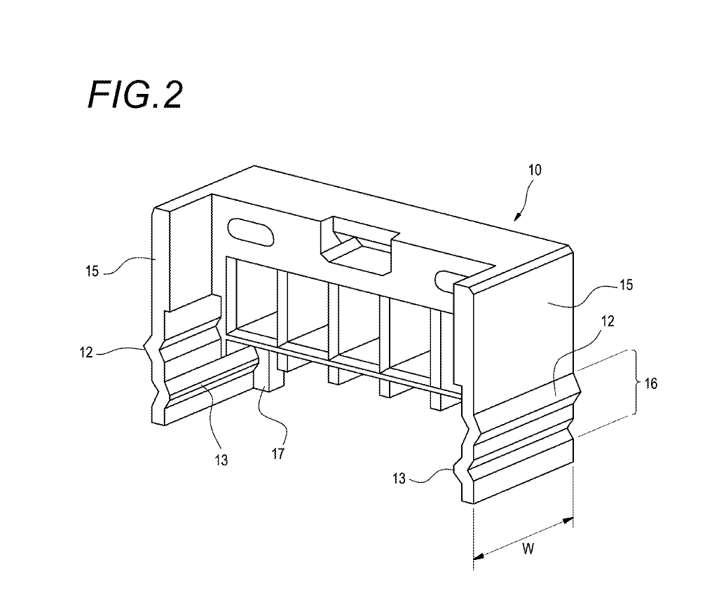

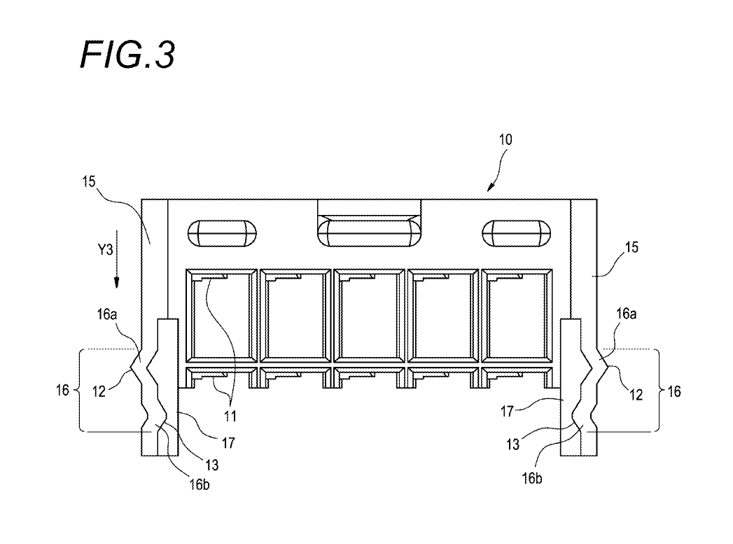

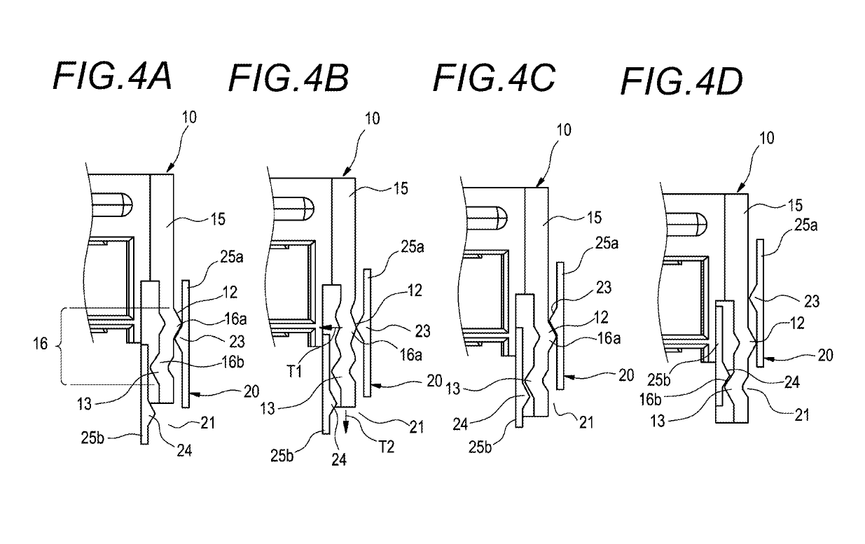

FIGS. 1 to 4D are schematic views explanatorily illustrating a housing body and a spacer of a connector with the use of a retaining structure of an attachment component according to a first embodiment of the present disclosure, FIG. 1 is an exploded perspective view illustrating the housing body and the spacer according to the first embodiment, FIG. 2 is an enlarged perspective view illustrating the spacer shown in FIG. 1, and FIG. 3 is an elevational view illustrating the spacer shown in FIG. 2. In addition, FIG. 4A is a schematic view explanatorily illustrating an insertion state that the spacer inserted into the spacer containing space of the housing body of the first embodiment is not yet provisionally retained, FIG. 4B is a schematic view explanatorily illustrating a state that the insertion is advanced from the state shown in FIG. 4A and the projection portion for provisionally retaining of the spacer is in a way of getting over a provisionally retaining portion of the housing, FIG. 4C is a schematic view explanatorily illustrating a state that the insertion is advanced from the state shown in FIG. 4B and the spacer is positioned on a provisionally retaining position, and FIG. 4D is a schematic view explanatorily illustrating a state that the insertion is advanced from the state shown in FIG. 4C and the spacer is positioned on a completely retaining position.

As illustrated in FIG. 1, a connector 1 having a retaining structure of an attachment component according to the present disclosure includes a spacer 10 as the attachment component and a housing body 20 having a spacer containing space 21 as a component containing space into which the spacer 10 is inserted to be attached thereto in a direction of arrow Y2.

The spacer 10 is a component which is to be attached to the spacer containing space 21 as a double retaining mechanism of a terminal metal fitting (not shown) attached to a terminal insertion hole 22 of the housing body 20. As illustrated in FIGS. 2 and 3, the spacer has terminal retaining portions 11, projection portions 12 for provisionally retaining and projection portions 13 for completely retaining.

Each of the terminal retaining portions 11 is a projection which is adapted to be engaged with a terminal metal fitting attached to the terminal insertion hole 22 so as to prevent the terminal metal fitting from dropping-off.

Each of the projection portions 12 for provisionally retaining is a projection which is retained to a provisionally retaining portion 23 provided on the housing body 20 as illustrated in FIG. 4C when an insertion length of the spacer 10 into the spacer containing space 21 reaches a first specified value so that the spacer 10 is positioned on a provisionally retaining position (shown in FIG. 4C). In a state that the spacer 10 is positioned on the provisionally retaining position, the terminal retaining portion 11 is not placed in the terminal insertion hole 22 so that inserting and extracting of the terminal metal fitting to or from the terminal insertion hole 22 is permitted.

The projection portion 13 for completely retaining is a projection which is retained to a completely retaining portion 24 provided on the housing body 20 as illustrated in FIG. 4D when an insertion length of the spacer 10 into the spacer containing space 21 exceeds the first specified value to reach a second specified value so that the spacer 10 is positioned on a completely retaining position (shown in FIG. 4D). In a state that the spacer 10 is positioned on the completely retaining position, the terminal retaining portion 11 is placed in the terminal insertion hole 22 to be engaged with the terminal metal fitting so that dropping-off of the terminal metal fitting is restricted.

In the case of the embodiment, as illustrated in FIG. 3, the projection portion 12 for provisionally retaining and the projection portion 13 for completely retaining are respectively provided on a pair of outer side walls 15 as side walls extending along the insertion direction of the spacer 10 (in a direction of arrow Y3 in FIG. 3).

To be more specific, each of the outer side walls 15 has a wave shaped plate section 16. Each of the wave shaped plate sections 16 is formed in a shape of a wave progressing along the insertion direction shown by arrow Y3 shown in FIG. 3. Two projection portions 16a and 16b which are projected in the opposite directions are continuously formed on each of the wave shaped plate sections 16 so that the wave shaped plate sections 16 have the shape of the wave. In the case of the embodiment, the projection portion 16a of one of the two wave shaped projection portions 16a and 16b formed on each of the wave shaped plate sections 16 is utilized as the projection portion 12 for provisionally retaining, and the other projection portion 16b is utilized as the projection portion 13 for completely retaining.

That is, in the case of the embodiment, the two projection sections 16a and 16b utilized as the projection portion 12 for provisionally retaining and the projection portion 13 for completely retaining are a pair of concave and convex portions continuously formed in a shape of a wave.

When the wave shaped projection portions 16a and 16b receive a pressure load, the projection portions 16a and 16b are elastically deformed by the pressure load to be in a flat shape as illustrated by arrow T1 in FIG. 4B, and thereby the wave shaped plate section 16 is expanded in the insertion direction as illustrated by arrow T2 in FIG. 4B.

As illustrated in FIG. 3, the wave shaped plate section 16 is provided at only a partial range of each of the outer side walls 15 along the insertion direction. As illustrated in FIG. 2, the wave shaped projection portions 16a and 16b on the wave shaped plate section 16 are formed over the whole width W of each of the outer side walls 15.

In the case of the embodiment, as illustrated in FIG. 3, a single rib 17 for increasing the elastic strength of the two projection portions 16a and 16b is provided on a face (an inner face) of each of the wave shaped plate sections 16 so as to extend in the insertion direction.

A pair of partition walls 25a and 25b which are opposed to each other so that the outer side wall 15 of the spacer 10 is arranged between partition walls 25a and 25b in the spacer containing space 21 of the housing body 20 as illustrated in FIG. 4. The provisionally retaining portion 23 disposed on the housing body 20 is a projection which is projected from the partition wall 25a toward the partition wall 25b side. The completely retaining portion 24 is a projection which is projected from the partition wall 25b toward the partition wall 25a side. Width dimensions (length dimensions extending in a direction perpendicular to a paper face in FIG. 4) of the provisionally retaining portion 23 and the completely retaining portion 24 are set so as to correspond to a required retaining force.

To be brief, the retaining structure of an attachment component in a connector of the embodiment is configured such that two projection portions 16a and 16b continuously formed in the shape of the wave on each of the wave shaped plate sections 16 at both outer side walls 15 of the spacer 10 are made to be the projection portion 12 for provisionally retaining and the projection portion 13 for completely retaining which are respectively latched by the provisionally retaining portion 23 and the completely retaining portion 24 in the housing body 20.

In the case of the retaining structure of an attachment component in the first embodiment as described above, the projection portion 12 for provisionally retaining and the projection portion 13 for completely retaining provided on the spacer 10, are the wave shaped projection portions 16a and 16b on each of the wave shaped plate sections 16 which are respectively formed on the pair of outer side walls 15 extending along the insertion direction of the spacer 10. The projection portion 12 for provisionally retaining or the projection portion 13 for completely retaining functions as a plate spring that elastically deforms in a flat shape by the pressure load that the projection portion 16a or 16b receives when it is brought into contact with the provisionally retaining portion 23 or the completely retaining portion 24 at the housing body 20 side.

Therefore, even in a case where a slit or the like is not provided, it is possible to complete engagement between the projection portion 12 for provisionally retaining and the provisionally retaining portion 23 or between the projection portion 13 for completely retaining and the completely retaining portion 24 without applying an excessive load to the parts to be mutually engaged between the spacer 10 and the housing 20.

Consequently, in accordance with the configuration of the connector with the retaining mechanism described in the first embodiment, the parts to be mutually engaged between the spacer 10 and the housing body 20 can be safely moved to an engaged state by elastic deformation of one of the spacer 10 and the housing body 20 without causing a damage even when a slit or the like which may require an expensive sliding die is not provided.

In addition, it is possible to obviate the need for a sliding die which is adapted to mold the housing body or the like and has a complicated structure so that a structure of a molding die can be simplified, and thereby the manufacturing cost can be reduced.

Further, in the case of the retaining structure of the attachment component in the first embodiment as described above, the projection portion 12 for provisionally retaining or the projection portion 13 for completely retaining provided on the spacer 10, is formed to extend over the whole width W of the outer side wall 15 which is formed to extend along the insertion direction of the spacer 10 as illustrated in FIG. 2. As a result, the width dimension of the provisionally retaining portion 23 or the completely retaining portion 24 provided on the housing body 20 is made to be an engagement width between the spacer 10 and the housing body 20 so that it is possible to readily adjust the engagement strength between the spacer 10 and the housing body 20 only by changing the width dimension of the provisionally retaining portion 23 or the completely retaining portion 24 provided on the housing body 20. Consequently, it is possible to facilitate the adjusting of the engagement strength between the spacer 10 and the housing body 20.

Moreover, in the case of the connector with the retaining structure in the first embodiment as described above, the projection portion 12 for provisionally retaining and the projection portion 13 for completely retaining provided on the spacer 10 are a pair of concave and convex portions continuously formed in the shape of the wave on the wave shaped plate section 16. Therefore, the length dimension of the wave shaped plate section 16 along the insertion direction thereof can be reduced to be one corresponding to one cycle of the wave as illustrated in the first embodiment. With this, as compared to a case in which the length of the wave shaped plate section 16 in the insertion direction is made to correspond to multiple cycles of the wave, the shape of the outer side wall 15 in the spacer containing space 21 can be simplified, and thereby moldability of the spacer 10 can be improved.

Moreover, in the case of the retaining structure of an attachment component in the first embodiment as described above, by adjusting the thickness or the like of the rib 17, the elastic strength of each of the two projection portions 16a and 16b on the wave shaped plate section 16 which functions as the projection portion 12 for provisionally retaining or the projection portion 13 for completely retaining provided on the spacer 10, can be readily adjusted, and thereby the projection portions 16a and 16b having the desired elastic strength can be readily obtained.

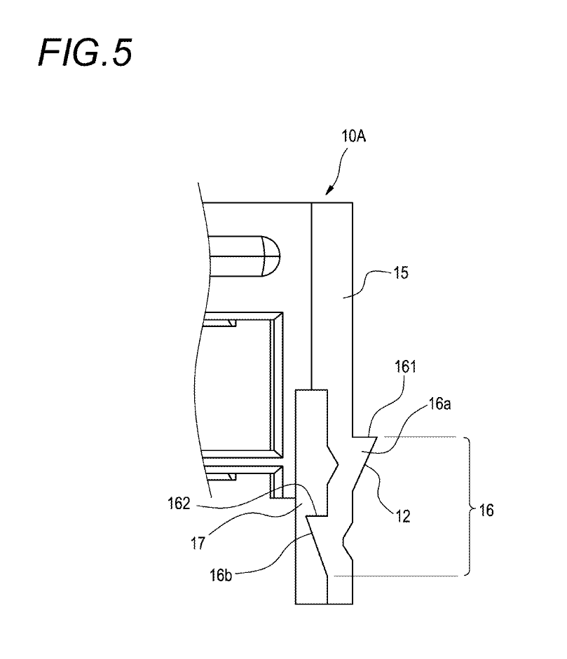

FIG. 5 is a schematic view illustrating a main part of a spacer having a retaining structure of an attachment component in a connector according to a second embodiment of the present disclosure.

A basic structure of the spacer 10A of the second embodiment can be the same as that of the spacer 10 of the first embodiment, and the elements or members the same as in the first embodiment are denoted by the same numerals, and their descriptions are omitted.

A point at which the spacer 10A of the second embodiment is different from the spacer 10 of the first embodiment, is an end face 161 of the projection portion 16a on the wave shaped plate section 16 to be engaged with the provisionally retaining portion 23 of the housing body 20 and an end face 162 of the projection portion 16b on the wave shaped plate section 16 to be engaged with the completely retaining portion 24 are made to be flat faces perpendicular to the insertion direction. Also, the provisionally retaining portion 23 and the completely retaining portion 24 respectively have end faces perpendicular to the insertion direction so as to be engaged with the end faces 161, 162 of the projection portions 16a, 16b. With this configuration, the engagement force of each of the projection portions 16a and 16b can be increased.

Meanwhile, the retaining structure of an attachment component in a connector of the present disclosure is not limited to the above described embodiments, but changes, modifications or the like can be made if necessary.

For example, the attachment component is not limited to the spacer described in the above embodiments, a holder which is to be inserted into a housing body to be attached thereto and positions a terminal metal fitting, can be used.

By the above configurations, a connector in which parts to be mutually engaged between an attachment component and a housing body can be safely moved to an engaged state by elastic deformation of one of them can be obtained.

What is claimed is:

1. A connector comprising:
a housing body that has a component containing space; and
an attachment component that is inserted in the component containing space of the housing body, and has a side wall extending in an insertion direction of the attachment component into the component containing space,
wherein the housing body includes a provisionally retaining portion and a completely retaining portion;
wherein the attachment component has a first projection portion which is retained to the provisionally retaining portion so as to position the attachment component on a provisionally retaining position when the attachment component is inserted into the component containing space by a first insertion length;
wherein the attachment component has a second projection portion which is retained to the completely retaining portion so as to position the attachment component on a completely retaining position when the attachment component is inserted into the component containing space by a second insertion length which is longer that the first insertion length; and
wherein the side wall of the attachment component includes a wave shaped plate section having elasticity, and the wave shaped plate section has the first projection portion and the second projection portion which are formed in a shape of a wave progressing along the insertion direction of the attachment component.

2. The connector according to claim 1, wherein when a pressure load is applied to at least one of the first projection portion and the second projection portion, the at least one of the first projection portion and the second projection portion is elastically deformed in a flat shape by the pressure load and the wave shaped plate section is expanded in the insertion direction of the attachment component.

3. The connector according to claim 1, wherein the first projection portion and the second projection portion extend over a whole width of the side wall in a direction perpendicular to the insertion direction of the attachment component.

4. The connector according to claim 1, wherein the first projection portion and the second projection portion a pair of concave and convex portions continuously formed on the wave shaped plate section.

5. The connector according to claim 1, wherein a rib for increasing elastic strength of the first projection portion and the second projection portion is extended on one face of the wave shaped plate section in the insertion direction of the attachment component.

6. The connector according to claim 1, wherein the first projection portion is formed on a first face of the wave shaped plate section and the second projection portion is formed on a second face of the wave shaped plate section which is opposite to the first face.

7. The connector according to claim 1, wherein the wave shaped plate section is arranged between the provisionally retaining portion and the completely retaining portion when the attachment component is inserted into the component containing space by the second insertion length.
